(19) United States
(12) Patent Application Publication
(10) Pub. No.: US 2017/0116146 A1
(43) Pub. Date: Apr. 27, 2017

(54) CONTROL METHOD AND CONTROL DEVICE FOR A MOBILE TERMINAL

(71) Applicants: LE HOLDINGS (BEIJING) CO., LTD., Beijing (CN); Lemobile Infornation Technology (Beijing) Co., Ltd, Beijing (CN)

(72) Inventor: Yaqiong LIU, Beijing (CN)

(21) Appl. No.: 15/232,673

(22) Filed: Aug. 9, 2016

Related U.S. Application Data
(63) Continuation of application No. PCT/CN2016/088390, filed on Jul. 4, 2016.

(30) Foreign Application Priority Data
Oct. 26, 2015 (CN) 201510705729.3

(51) Int. Cl. G06F 13/38; G06F 9/44; G06F 13/42

(52) U.S. Cl. CPC G06F 13/385; G06F 13/4282; G06F 9/4413

(57) ABSTRACT

An embodiment of the present disclosure discloses a control method and a control device for a mobile terminal in order to solve the problem in the prior art that power consumption of the mobile terminal increases as an HPD function of an HDMI is enabled all the time alley the mobile terminal is powered on. The mobile terminal comprises a USB interface and an HDMI, and an operating mode of the USB interface is compatible with a USB OTG mode and an MHL mode of the mobile terminal. The control method for the mobile terminal comprises the following steps: a USB OTG driver detects whether MHL equipment is plugged in the USB interface; and the USB OTG driver triggers to enable an HPD function of the HDMI if the USB OTG driver detects that the MHL equipment is plugged in the USB interface.

### CROSS-REFERENCE TO RELATED APPLICATIONS

The present disclosure is a continuation of International Application No. PCT/CN2016/088390 filed on Jul. 4 2016, which is based upon and claims priority to Chinese Patent Application No. CN201510705729.3. entitled “CONTROL METHOD AND CONTROL DEVICE FOR A MOBILE TERMINAL”, filed to State Intellectual Property Office of The P.R.C on Oct. 26, 2015, the entire contents of all of which are incorporated herein by reference.

### FIELD OF TECHNOLOGY

Embodiments of the present disclosure relates to the technical field of mobile terminals, in particular, to a control method and a control device for a mobile terminal.

### BACKGROUND

With the rapid development of communication technology, mobile terminals have become essential means of communication in people's lives, and provide users many facilitating conditions. As the users ask for higher and higher user experience of the mobile terminals, mobile terminals are witnessing increasingly rich varieties and increasingly powerful functions. In order to meet the requirement for high-quality graphics and images in the digital age, an HDMI (High Definition Multimedia Interface) is generally arranged in a mobile terminal. As a digitized video/audio interface technology and a specific digitized interface which is suitable for image transmission, the HDMI can simultaneously transmit audio and image signals, and therefore the communication between the mobile terminal and a sink terminal such as an intelligent display device is more convenient.

The HDMI has a major advantage of supporting hot plug, and therefore equipment provided with the HDMI has a “plug-and-play” characteristic, and an automated negotiation is available between a signal source and the sink terminal for the automatic selection of the most appropriate video/audio format.

The HDMI has an HPD (Hot Plug Detect) function, and a hot plug event can be detected after the HPD function is enabled. In the prior art, the HPD function of the HDMI is enabled all the time after the mobile terminal is powered on for the availability of detecting the hot plug event, and therefore the plug-and-play of the equipment is realized. However, operation of the HPD function is not needed when the detection of the hot plug event is not required, and accordingly the means employed in the prior art increases power consumption of the mobile terminal.

An embodiment of the present disclosure discloses a control method and a control device of a mobile terminal in order to solve the problem in the prior art that the power consumption of the mobile terminal increases as the HPD function of the HDMI is enabled all the time after the mobile terminal is powered on.

According to one aspect of the present disclosure, an embodiment of the present disclosure provides a control method for a mobile terminal, wherein the mobile terminal includes a USB (Universal Serial Bus) interface and an HDMI, and an operating mode of the USB interface is compatible with a USB OTG (On-The-Go) mode and an MHL (Mobile High-Definition Link) mode of the mobile terminal,

the control method including:

a USB OTG driver detects whether MHL equipment is plugged in the USB interface;

and, if the USB OTG driver detects that the MHL equipment is plugged in the USB interface, the USB OTG driver triggers to enable an HPD function of the HDMI.

According to another aspect of the present disclosure, one embodiment of the present disclosure provides a control device for a mobile terminal, wherein the mobile terminal includes a USB interface and an HDMI, and an operating mode of the USB interface is compatible with a USB OTG mode and an MHL mode of an high-definition video & audio standard interface of the mobile terminal,

the control device includes a USB OTG driver, wherein the USB OTG driver includes:

a plug-in detection module, which is configured to detect whether MHL equipment is plugged in the USB interface;

and an enabling triggering module, which is configured to triggering to enable an HPD function of the HDMI when the plug-in detection module detects that the MHL equipment is plugged in the USB interface.

According to a further aspect of the present disclosure, a computer program is provided, including a computer readable code, wherein the computer readable code triggers the mobile terminal to execute the control method of the mobile terminal when operating on the mobile terminal.

According to another further aspect of the present disclosure, a computer readable medium is provided, wherein the computer readable program is stored in the computer readable medium.

The present disclosure has the following beneficial effects:

according to the control method and the control device of the mobile terminal provided by embodiments of the present disclosure, the HPD function of the HDMI is not enabled immediately after the mobile terminal is powered on; instead, the USB OTG driver detects whether the MHL equipment is plugged in the USB interface of the mobile terminal, and the HPD function of the HDMI is enabled if the USB OTG driver detects that the MHL equipment is plugged in the USB interface. Therefore, an embodiment of the present disclosure provides a means of dynamically enabling the HPD function of the HDMI. The HPD function is not enabled until the HPD function is in real need, and therefore unnecessary power consumption caused by keeping operating the HPD function when the detection of a hot plug event is not required can be avoided so as to achieve the purpose of lowering the power consumption of the mobile terminal.

The above description is only a summary of the technical scheme of the present disclosure. In order to clearly illustrate the technical means of the present disclosure to ensure the present disclosure is implementable according to content of the specification, and in order to make the above and other purposes, characteristics and advantages of the present disclosure more apparent to understand, embodiments of the present disclosure are specifically illustrated as follows.

### BRIEF DESCRIPTION OF THE DRAWINGS

In order to clearly illustrate the technical solution of the embodiments of the present disclosure or in the prior art, the drawings which are required for the description in the embodiments or in the prior art, will be briefly described in the following; it is obvious that the described drawings are only related to some embodiments of the present disclosure. Based on the described drawings herein, those of ordinary skill in the art can obtain other drawings, without any inventive work.

FIG. 1 is a step flow chart of a control method for a mobile terminal according to a first embodiment of the present disclosure.

FIG. 2 is a schematic diagram of the connection of a source terminal and a sink terminal according to the first embodiment of the present disclosure.

FIG. 3 is a step flow chart of a control method for a mobile terminal according to a second embodiment of the present disclosure.

FIG. 4 is a step flow chart of a control method for a mobile terminal according to a third embodiment of the present disclosure.

FIG. 5 is a structure block diagram of a control device of a mobile terminal according to a fourth embodiment of the present disclosure.

FIG. 6 is a structure block diagram of a control device of a mobile terminal according to a fifth embodiment of the present disclosure.

FIG. 7 schematically illustrates a block diagram of a mobile terminal used to execute the method according to the present disclosure.

FIG. 8 schematically illustrates a storage cell used to keep or carry a program code for realizing the method according to the present disclosure.

### DESCRIPTION OF THE EMBODIMENTS

In order to make objects, technical details and advantages of the embodiments of the present disclosure apparent, the technical solutions in the embodiments of the present disclosure will be described in a clearly and fully understandable way in connection with the drawings related to the embodiments of the present disclosure. It is obvious that the described embodiments are just a part but not all of the embodiments of the present disclosure. Based on the described embodiments herein, those of ordinary skill in the art can obtain other embodiment(s), without any inventive work, which should be within the scope of the present disclosure.

### First Embodiment

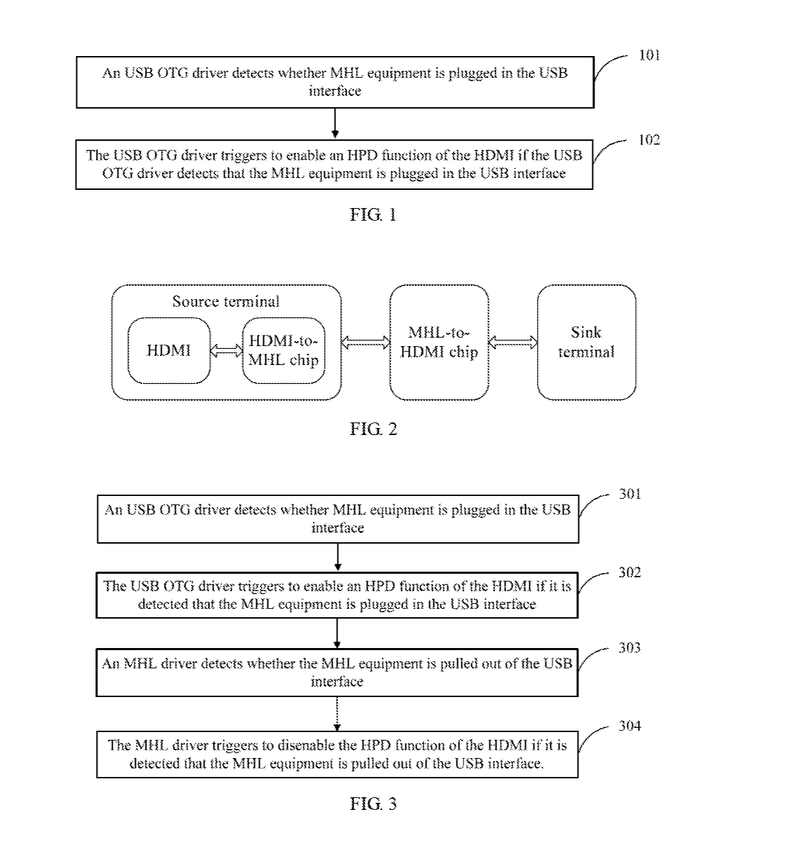

With reference to FIG. 1, which illustrates a steps flow chart of a control method for a mobile terminal according to a first embodiment of the present disclosure.

The control method for the mobile terminal according the embodiment of the present disclosure may include steps as the follows.

Step 101, a USB OTG driver detects whether MHL equipment is plugged in a USB interface.

The mobile terminal according to the embodiment of the present disclosure includes the USB interface and an HDMI, wherein the HDMI has 19 pins, and is not suitable for being directly applied to portable equipment such as the mobile terminal. Therefore, a built-in HDMI is generally arranged at the inner part of the mobile terminal, and a MHL is arranged in the mobile terminal. The MHL is a mobile high-definition link for connecting a portable electronic device, and has only 5 pins, so that the storage and transmission of data become much easier. The MHL supported by the mobile terminal can realize a video transmission from the mobile terminal to a sink terminal (such as intelligent display equipment) to play. With reference to FIG. 2, which illustrates a schematic diagram of the connection of a source terminal and a sink terminal according to the first embodiment of the present disclosure, an HDMI and an HDMI-to-MHL chip are arranged in the source terminal (a mobile terminal), an MHL (which is not shown in FIG. 2) is further arranged in the source terminal, an HDMI-to-MHL chip is arranged between the HDMI and the MHL, and is configured to transform an HDMI format into an MHL format for the availability of MHL transmission; while the sink terminal (the intelligent display equipment) can play a video in HDMI format, so that it is further required to arrange an MHL-to-HDMI chip between the sink terminal and the source terminal, and the MHL-to-HDMI chip is configured to transform the MHL format into the HDMI format. The video of the mobile terminal can be displayed on the intelligent display equipment by plugging one end of the MHL-to-HDMI chip in the sink terminal and the other end of the same in the source terminal.

Further, considering that to individually arrange the MHL on the mobile terminal will increase the number of hardware interfaces of the mobile terminal, an interface sharing technology is accordingly employed in order to reduce the number of the hardware interfaces. As an external bus standard, a USB is used to specify the connection and communication between a computer and external equipment. A USB interface is an interface to standardize and simplify the connection of peripheral equipment of the computer, and can support a plug-and-play function and a hot plug function of the equipment. The USB interface is generally arranged in the mobile terminal, and accordingly the MHL is generally shared through an existing USB interface in the mobile terminal at present, so that the structure of the mobile terminal is simpler. As the MHL is shared through the USB interface, the USB interface can be compatible with a USB OTG (OTG is the abbreviation of On-The-Go, and is mainly applied to connecting various different equipment or mobile equipment for data exchange, and OTG technology is to realize data transmission between different equipment without a host) mode and an MHL mode. When USB OTG equipment is plugged in the USB interface and the USB interface operates in the USB OTG mode, a USB OTG driver is employed and when the MHL equipment is plugged in the USB interface and the USB interface operates in the MHL mode, an MHL driver is employed.

As above, the HDMI in the mobile terminal is communicated with the MHL, and therefore the equipment which is plugged in the USB interface of the mobile terminal shall be the MHL equipment when the HDMI is employed. In the prior art, an HPD function of the HDMI is immediately enabled all the time after the mobile terminal is powered on, and such means will increase power consumption of the mobile terminal. With respect to the above problem, and considering that it is in real need to enable the HPD function of the HDMI when the HDMI of the mobile terminal is required for use, the HPD function of the HDMI is not enabled directly after the mobile terminal is powered on according to the embodiment of the present disclosure, and instead the USB interface is monitored through the USB OTG driver to detect whether the MHL equipment is plugged in the USB interface.

Step 102, the USB OTG driver triggers to enable the HPD function of the HDMI if it is detected that the MHL equipment is plugged in the USB interface.

If it is detected that the MHL equipment is plugged in the USB interface in step 101, the employment of the HDMI is required at this moment, and the USB OTG driver can trigger to enable the HPD function of the HDMI in this case. If it is detected that no MHL equipment is plugged in the USB interface, it is temporarily not needed to enable the HPD function of the HDMI, and instead corresponding operations shall be executed according to actual circumstances in this case. For example, the operation of transmitting data is executed if the USB OTG equipment is plugged in the USB interface.

According to the control method for the mobile terminal provided by the embodiment of the present disclosure, the HPD function of the HDMI is not enabled immediately after the mobile terminal is powered on; instead, the USB OTG driver detects whether the MHL equipment is plugged in the USB interface of the mobile terminal, and the HPD function of the HDMI is enabled if it is detected that the MHL equipment is plugged in the USB interface. Accordingly, the embodiment of the present disclosure provides a means of dynamically enabling the HPD function of the HDMI. The HPD function is not enabled until the HPD function is in real need, and therefore unnecessary power consumption caused by keeping operating the HPD function when the detection of a hot plug event is not required can be avoided so as to achieve the purpose of lowering the power consumption of the mobile terminal.

### Second Embodiment

With reference to FIG. 3, which illustrates a steps flow chart of a control method for a mobile terminal according to a second embodiment of the present disclosure.

A control method for a mobile terminal according to the embodiment of the present disclosure may include steps as follows.

Step 301, a USB OTG driver detects whether MHL equipment is plugged in a USB interface.

The USB interface of the mobile terminal includes a VBUS pin, a USB_ID pin, a USB_DP pin, a USB_DM pin and a GND pin, wherein the VBUS pin is in connection with a Power IC of the mobile terminal, the voltage for the VBUS pin is 5V in normal operation, and the GND pin is grounded. When USB OTG equipment or MHL equipment is plugged in or pulled out of the USB interface, electrical level of the USB_ID pin will change to generate an interrupt signal of the USB_ID pin. For example, when the USB OTG equipment or the MHL equipment is plugged in the USB interface, the electrical level of the USB_ID pin will be lowered (namely, the electrical level of the USB_ID pin will become a low electrical level), and accordingly the interrupt signal of the USB_ID pin is generated; when the USB OTG equipment or the MHL equipment is pulled out of the USB interface, the electrical level of the USB_ID pin will be raised (namely, the electrical level of the USB_ID pin will become a high electrical level), and accordingly the interrupt signal of the USB_ID pin is generated. An interrupt processing function for processing the interrupt signal can be registered in an AP (Application Processor) of the mobile terminal in advance. When the USB OTG equipment or the MHL equipment is plugged in the USB interface, the USB OTG driver of the mobile terminal can receive the interrupt signal of the USB_ID pin, and the interrupt processing function can be invoked to process the interrupt signal after the receiving so as to further determine which kind of equipment is plugged in the USB interface.

Preferably, the step 301 may include substeps as follows.

Substep a1, the USB OTG driver detects the electrical level of the USB_ID pin after receiving the interrupt signal of the USB_ID pin; execute substep a2 if the USB_ID pin is at a low electrical level; and execute substep a4 if the USB_ID pin is at a high electrical level;

when the USB OTG equipment or the MHL equipment is plugged in the USB interface of the mobile terminal, hardware will report the interrupt signal in connection with the USB_ID pin, and the USB OTG driver in the mobile terminal will receive the interrupt signal of the USB_ID pin and detects the electrical level of the USB_ID pin after receiving the interrupt signal of the USB_ID pin.

Substep a2, reading resistance to ground of the USB_ID pin if it is detected that the electrical level of the USB_ID pin is low electrical level, executing substep a3 if the value of the resistance to ground is 1KΩ, and executing substep a4 if the value of the resistance to the ground is not 1KΩ;

external equipment corresponds to a resistance value between the USB_ID pin and the ground, and such resistance value is in bridge connection with the external equipment; the resistance to ground of the USB_ID pin can be further read if the USB OTG driver of the mobile terminal detects that the electrical level of the USB_ID pin is low electrical level.

Substep a3, confirming that the MHL equipment is plugged in the USB interface if the value of the resistance to ground of the USB_ID pin is 1KΩ.

When the USB OTG equipment or the MHL equipment is plugged in the USB interface, the value of the resistance to the ground of the USB_ID pin is different. It can be blow from the MHL specification, the value of the resistance to the ground of the USB_ID pin is 1KΩ when the MHL equipment is plugged in the USB interface; and therefore it can be confirmed that the MHL equipment is plugged in the USB interface if it is detected that the value of the resistance to ground of the USB_ID pin is 1kΩ.

Substep a4, confirming that no MHL equipment is plugged in the USB interface.

Confirm that no MHL equipment is plugged in the USB interface if it is detected in substep a1 that the USB_ID pin is at high electrical level; and confirm that no MHL equipment is plugged in the USB interface if it is read in substep a2 that the resistance to ground of the USB_ID pin is not 1KΩ.

Step 302, the USB OTG driver triggers to enable the HPD function of the HDMI if it is detected that the MHL equipment is plugged in the USB interface.

If it is detected that the MHL equipment is plugged in the USB interface in step 301, the employment of the HDMI of the mobile terminal is required at this moment, and the USB OTG driver can trigger to enable the HPD function of the HDMI in this case, and a hog plug event can be detected after the HPD function is enabled so as to realize the signal transmission between the mobile terminal and intelligent display equipment (the specific process will be illustrated in the third embodiment of the present disclosure). If it is detected that no MHL equipment is plugged in the USB interface in step 301, it is temporarily not needed to enable the HPD function of the HDMI.

Step 303 that an MHL driver detects whether the MHL equipment is pulled out of the USB interface.

According to the embodiment of the present disclosure, it is further available for the MHL driver to detect whether the MHL equipment is pulled out of the USB interface. As described in step 301, when the UDB OTG equipment or the MHL equipment is pulled out of the USB interface, the electrical level of the USB_ID pin will change to generate an interrupt signal of the USB_ID pin. According to the embodiment of the present disclosure, when the MHL equipment is pulled out of the USB interface, the MHL driver of the mobile terminal can receive the interrupt signal of the USB_ID pin. Moreover, the MHL driver corresponds to an internal storage. The internal storage is configured to store data which can identify the plug-in or pulled-out of the MHL equipment (with respect to specific data form, those of ordinary skill in the art can process correspondingly according to practical experiences, and there is no limit in the embodiment of the present disclosure). When the MHL equipment is plugged in or pulled out of the USB interface, the MHL driver will automatically trigger to update the data in the internal storage. Therefore, preferably, the step 303 may include substeps as follows.

substep b1, reading corresponding data in the internal storage when the MHL driver receives the interrupt signal of the USB_ID pin; and

substep b2, confirming that the MHL equipment is pulled out of the USB interface if the data in the internal storage is the data for indicating the pull-out of the MHL equipment.

Step 304, the MHL driver triggers to disenable the HPD function of the HDMI if it is detected that the MHL equipment is pulled out of the USB interface.

If it is detected in step 303 that the MHL equipment is pulled out of the USB interface, the employment of the HDMI of the mobile terminal is not required at the moment, and therefore the MHL driver can trigger to disenable the HPD function of the HDMI to further lower the power consumption of the mobile terminal in this case.

The embodiment of the present disclosure provides a method for dynamically controlling the HPD function of the HDMI. The HPD function of the HDMI is enabled when the employment of the HDMI of the mobile terminal is required and the HPD function of the HDMI is disenabled when the HDMI of the mobile terminal is not required any more so as to achieve the purposes of effectively lowering the power consumption of the mobile terminal and reducing the battery loss of the mobile terminal.

### Third Embodiment

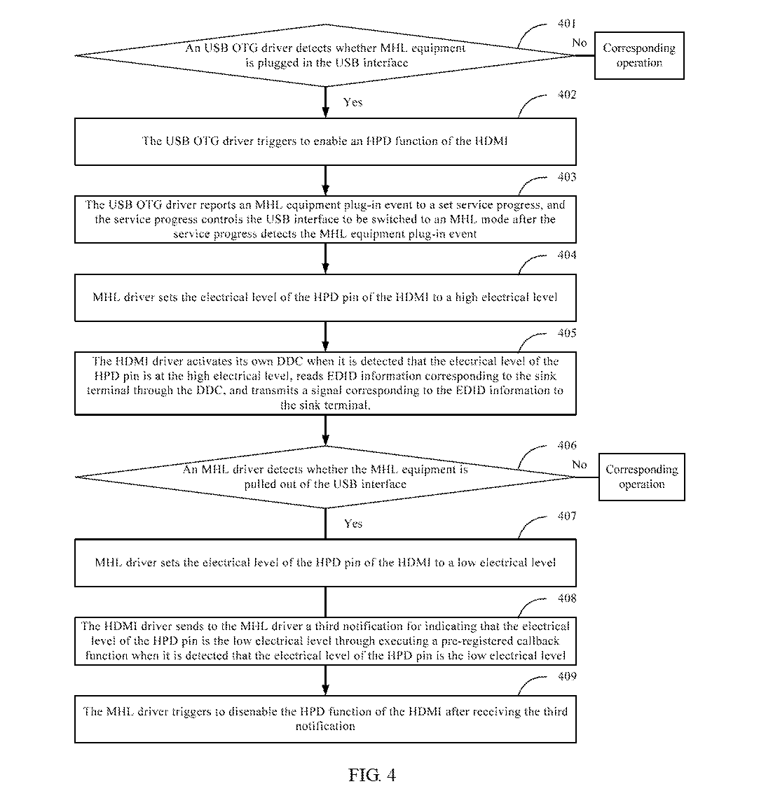

With reference to FIG. 4, which illustrates a steps flow chart of a control method for a mobile terminal according to a third embodiment of the present disclosure.

The control method for the mobile terminal according to the embodiment of the present disclosure may include steps as follows.

Step 401, a USB OTG driver detects whether MHL equipment is plugged in a USB interface. Execute step 402 if it is detected that the MHL equipment is plugged in the USB interface, or execute a corresponding operation if it is detected that no MHL equipment is plugged in the USB interface.

wherein, the corresponding operation can be executed according to actual circumstances; for example, execute the operation of transmitting data if it is detected that USB OTG equipment is plugged in the USB interface; for another example, execute no operation if it is detected that no equipment is plugged in the USB interface, etc.

Step 402, the USB OTG driver triggers to enable an HPD function of an HDMI.

The HDMI includes an HPD pin. An HDMI driver does not respond to an electrical level variation of the HPD pin so as to execute corresponding operations until the HPD function of the HDMI is enabled. For example, execute the operation of transmitting a signal if it is detected that the HPD pin is at a high electrical level. In the embodiment of the present disclosure, the HPD function of the HDMI can be further triggered and enabled if the USB OTG driver detects that MHL equipment is plugged in the USB interface. Preferably, the process of the USB OTG driver to trigger to enable the HPD function of the HDMI may include the following: the USB OTG driver sends to an MHL driver a first notification which indicates that the MHL equipment is plugged in the USB interface; the MHL driver sends to the HDMI driver a second notification which indicates to enable the HPD function of the HDMI; and the HDMI driver enables the HPD function of the HDMI after receiving the second notification.

Step 403, the USB OTG driver reports an MHL equipment plug-in event to a set service progress, wherein the service progress controls the USB interface to be switched to an MHL mode after the service progress detects the MHL equipment plug-in event.

The service progress for switching an operating mode of the USB interface can be set in the mobile terminal; the MHL equipment plug-in event can be reported to the service progress after the USB OTG driver detects that the MHL equipment is plugged in the USB interface; and the service progress can control the USB interface to be switched to the MHL mode after the MHL equipment plug-in event is detected.

In the embodiment of the present disclosure, the USB interface is further in connection with a change-over switch. The change-over switch can be switched to an MHL controller corresponding to the MHL mode of the USB interface or a USB OTG controller corresponding to a USB OTG mode of the USB interface, and the switching of corresponding operating mode of the USB interface can be realized through the change-over switch. Therefore, the process of switching the operating mode of the USB interface to the MHL mode can be realized through controlling the change-over switch to be switched to the corresponding MHL controller.

Step 404, the MHL driver sets an electrical level of an HPD pin of the HDMI to a high electrical level.

When the MHL equipment is plugged in the USB interface, the mobile terminal is in connection with a sink terminal such as intelligent display equipment at the moment, so that it is required for the mobile terminal to transmit signals to the sink terminal. However, the primary electrical level of the HPD pin in the HDMI is a low electrical level, and the HDMI driver executes the operation of transmitting the signals when it is detected that the HPD pin is at a high electrical level. Therefore, it is required for the MHL driver to set the electrical level of the HPD pin to the high electrical level before the signal transmission, so that a subsequent HDMI driver can detect the high electrical level.

Preferably, according to the embodiment of the present disclosure, before the electrical level of the HPD pin of the HDMI is set by the MHL driver to the high electrical level, the MHL driver can also confirm whether the MHL equipment is plugged in the USB interface for the second time and set the electrical level of the HPD pin after it is confirmed that the MHL equipment is plugged in the USB interface. As described in the second embodiment, when the MHL equipment is plugged in or pulled out of the USB interface, the updating of data in an internal storage corresponding to the MHL driver can be triggered automatically. Accordingly, the MHL driver can read the data in the corresponding internal storage. It is confirmed that the MHL equipment is plugged in the USB interface if the data in the internal storage is the data for indicating the plug-in of the MHL equipment.

Step 405, the HDMI driver activates its own DDC (Display Data Channel) when it is detected that the electrical level of the HPD pin is at the high electrical level, reads EDID (Extended Display Identification Data) information corresponding to the sink terminal through the DDC, and transmits a signal corresponding to the EDID information to the sink terminal.

The HDMI corresponds to the DDC, wherein the DDC is an information channel, which is established between a transmitting terminal and the sink terminal, and is configured to exchanging some configuration information between the transmitting terminal and the sink terminal. Corresponding EDID information is stored in a storage of the sink terminal, wherein the EDID information includes such information as a definition which can be supported by the sink terminal and the like, and the transmitting terminal can confirm to receive settings and functions displayed by the sink terminal according to the EDID information. Therefore, when it is detected that the electrical level of the HPD pin is the high electrical level, the HDMI driver will activate its own DDC, read the EDID information corresponding to the sink terminal through the DDC so as to confirm the definition of signals required to be transmitted to the sink terminal and to transmit to the sink terminal a signal corresponding to the EDID information, namely a signal corresponding to the definition of EDID information identification, and therefore the display of content such as a video and the like in the mobile terminal on the intelligent display equipment can be realized.

Step 406, the MHL driver detects whether the MHL equipment is pulled out of the USB interface. Execute step 407 if it is detected that the MHL equipment is pulled out of the USB interface; or execute a corresponding operation if it is detected that no MHL equipment is pulled out of the USB interface,

wherein, the corresponding operation executed can be ignored when the MHL driver detects that no MHL equipment is pulled out of the USB interface.

Step 407, the MHL driver sets the electrical level of the HPD pin of the HDMI to the low electrical level.

After the MHL equipment is pulled out of the USB interface, the mobile terminal is not in connection with the sink terminal any more at this moment, and therefore it is not required for the mobile terminal to transmit signals to the sink terminal. Accordingly, the MHL driver can set the electrical level of the HPD pin of the HDMI to a low electrical level, so that the subsequent HDMI driver can detect the low electrical level, and the mobile terminal does not transmit the signals to the sink terminal any more.

Step 408, the HDMI driver sends to the MHL driver a third notification for indicating that the electrical level of the HPD pin is the low electrical level through executing a pre-registered callback function when it is detected that the electrical level of the HPD pin is the low electrical level.

According to the embodiment of the present disclosure, when the MHL driver is initialized, a callback function, which can be invoked by the HDMI driver will be registered, and the callback function will be registered into the HDMI driver. The callback function is a function, which is invoked through a function pointer. If a pointer of a certain function is transferred to another function as a parameter, when such pointer is used to invoke the function to which the pointer points, such function can be called as the callback function. The HDMI driver sends to the MHL driver a third notification for indicating that the electrical pin of the HPD pin is the low electrical level through executing the callback function when it is detected that the electrical level of the HPD pin is the low electrical level.

Step 409, the MHL driver triggers to disenable the HPD function of the HDMI after receiving the third notification.

The MHL driver can confirm that it is not required to use the HPD function of the HDMI after receiving the third notification; namely, it is not required for the HDMI driver to respond to the electrical level variation of the HPD pin, and therefore the MHL driver will trigger to disenable the HPD function of the HDMI. Preferably, the process for the MHL driver to trigger to disenable the HPD function of the HDMI may include the following: The MHL driver sends to the HDMI driver a fourth notification for indicating to disenable the HPD function of the HDMI through executing the callback function; and the HDMI driver disenables the HPD function of the HDMI after receiving the fourth notification.

According to the embodiment of the present disclosure, the HPD function of the HDMI can be controlled dynamically through determining the plug-in and pull-out of the MHL equipment, so that power consumption of the mobile terminal can be lowered effectively, and battery loss of the mobile terminal can be reduced.

With respect to the embodiments of the above methods, in order to realize brief description, the methods are described as the combination of a series of actions. However, it should be blown for those skilled in the art that the present disclosure is not subjected to the order of the described actions, as some steps can employ other orders or can be executed at the same time according to the present disclosure. Moreover, it should be known for those skilled in the art that the embodiments described in the specification all belong to preferable embodiments and associated actions and modules are not necessarily required in the present disclosure.

### Fourth Embodiment

With reference to FIG. 5, which illustrates a structure block diagram of a control device of a mobile terminal according to a fourth embodiment of the present disclosure, wherein the mobile terminal may include a USB interface and an HDMI, and an operating mode of the USB mode is compatible with a USB OTG mode and an MHL mode.

According to the embodiment of the present disclosure, the control device for the mobile terminal may include a USB OTG driver 51, wherein the USB OTG driver 51 may include:

a plug-in detection module 511, which is configured to detect whether MHL equipment is plugged in the USB interface;

and an enabling triggering module 512, which is configured to trigger to enable an HPD function of an HDMI when the plug-in detection module detects that the MHL equipment is plugged in the USB interface.

According to the control device for the mobile terminal provided by the embodiment of the present disclosure, the HPD function of the HDMI is not enabled immediately after the mobile terminal is powered on; instead, the control device detects whether MHL equipment is plugged in the USB interface of the mobile terminal. If it is detected that the MHL equipment is plugged in the USB interface, the HPD function of the HDMI is enabled. Accordingly, the embodiment of the present disclosure provides a means of dynamically enabling the HPD function of the HDMI The HPD function is not enabled until the HPD function is in real need, and therefore unnecessary power consumption caused by keeping operating the HPD function when the detection of a hot plug event is not required can be avoided so as to achieve the purpose of lowering the power consumption of the mobile terminal.

### Fifth Embodiment

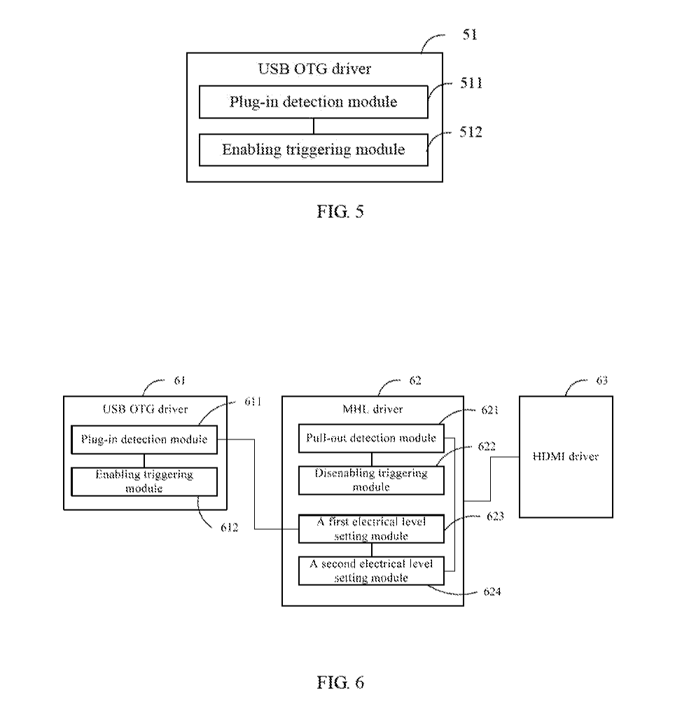

With reference to FIG. 6, which illustrates a structure block diagram of a control device of a mobile terminal according to a fifth embodiment of the present disclosure.

According to the embodiment of the present disclosure, the control device for the mobile terminal may include a USB OTG driver 61, wherein the USB OTG driver 61 may include a plug-in detection module 611, which is configured to detect whether MHL equipment is plugged in a USB interface, and an enabling triggering module 612, which is configured to trigger to enable an HPD function of an HDMI when the plug-in detection module detects that the MHL equipment is plugged in the USB interface.

Preferably, the enabling triggering module 612 is specifically configured to send to an MHL driver a first notification for indicating that the MHL equipment is plugged in the USB interface; the MHL driver sends to an HDMI driver a second notification for indicating to enable the HPD function of the HDMI after receiving the first notification; and the HDMI driver enables the HPD function of the HDMI after receiving the second notification.

Preferably, the control device for the mobile terminal may further include an MHL driver 62, wherein the MHL driver 62 may include a pull-out detection module 621, which is configured to detect whether the MHL equipment is pulled out of the USB interface; and an disenabling triggering module 622, which is configured to trigger to disenable the HPD function of the HDMI when the pull-out detection module detects that the MHL equipment is pulled out of the USB interface.

Preferably, the MHL driver 62 may further includes a first electrical level setting module 623, which is configured to set an electrical level of an HPD pin of the HDMI to a high electrical level after the enabling triggering module triggers to enable the HPD function of the HDMI.

Preferably, the MHL driver 62 may further includes a second electrical level setting module 624, which is configured to set the electrical level of the HPD pin of the HDMI to a low electrical level before the disenabling triggering module triggers to disenable the HPD function of the HDMI.

Preferably, the control device for the mobile terminal may further include an HDMI driver 63, which is configured to send to the MHL driver a third notification for indicating that the electrical level of the HPD pin is the low electrical level through executing a pre-registered callback function when it is detected that the electrical level of the HPD pin is the low electrical level. The disenabling triggering module 622 is specifically configured to send to the HDMI driver a fourth notification for indicating to disenable the HPD function of the HDMI through executing the callback function after receiving the third notification; and the HDMI driver disenables the HPD function of the HDMI after receiving the fourth notification.

In the embodiment of the present disclosure, the HPD function of the HDMI is enabled when the HDMI of the mobile terminal is required, and the HPD function of the HDMI is disenabled when it is not required to employ the HDMI of the mobile terminal so as to achieve the purposes of effectively lowering power consumption of the mobile terminal and reducing battery loss of the mobile terminal.

Device embodiments are briefly described herein as they are substantially similar to method embodiments; please refer to the description of the method embodiments for associated parts.

Apparatus embodiments described above are illustrative only, wherein the unit described as a separate part may be or may be not physically separated, a part displayed as the unit may be or may be not a physical unit, may be located in one place, or may be distributed on a plurality of network units. Some or all of the modules may be selected to achieve the objective of the solutions of the embodiments according to actual requirements. Those ordinarily skilled in the art may understand and implement it without investing creativity.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

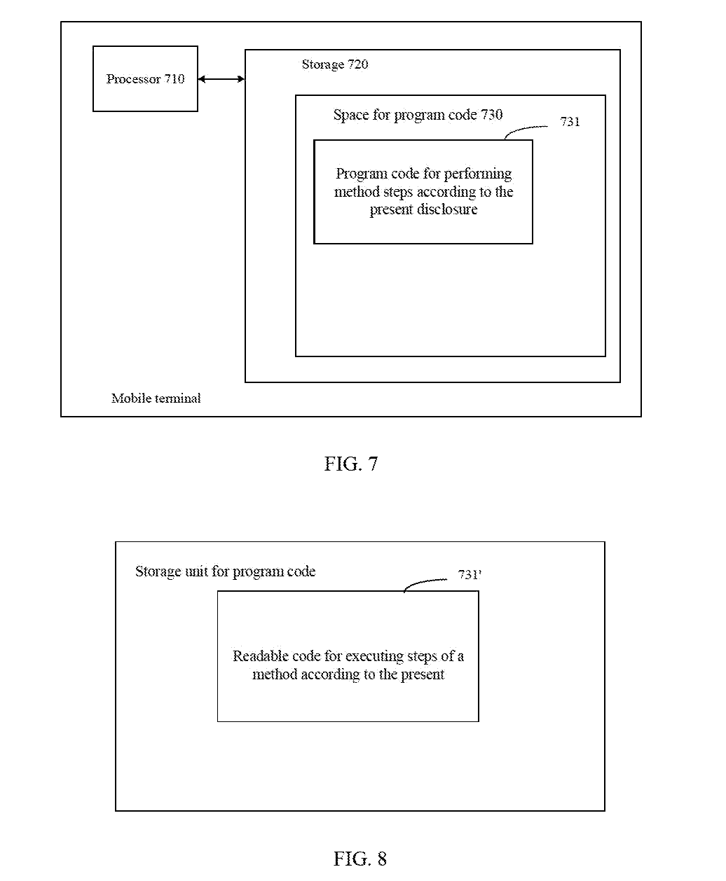

For example, FIG. 7 illustrates a block diagram of a mobile terminal for executing the method according the disclosure. Traditionally, the mobile terminal includes a processor 710 and a computer program product or a computer readable medium in form of a memory 720. The memory 720 could be electronic memories such as flash memory, EEPROM (Electrically Erasable Programmable Read-Only Memory), EPROM, hard disk or ROM. The memory 720 has a memory space 730 for executing program codes 731 of any steps in the above methods. For example, the memory space 730 for program codes may include respective program codes 731 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 8. The memory cells may be provided with memory sections, memory spaces, etc., similar to the memory 720 of the server as shown in FIG. 7. The program codes may be compressed for example in an appropriate form. Usually, the memory cell includes computer readable codes 731′ which can be read for example by processors 710. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, an reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

What is claimed is:

1. A control method for a mobile terminal, wherein: the mobile terminal comprises a USB interface and an HDMI, and an operating mode of the USB interface is compatible with a USB OTG mode and an MHL mode of the mobile terminal,
the control method comprising steps of:
a USB OTG driver detecting whether MHL equipment is plugged in the USB interface; and
the USB OTG driver triggering to enable an HPD function of the HDMI if the USB OTG driver detects that the MHL equipment is plugged in the USB interface.

2. The method according to claim 1, further comprising steps of:
an MHL driver detecting whether the MHL equipment is pulled out of the USB interface; and
the MHL driver triggering to disenable the HPD function of the HDMI if the MHL driver detects that the MHL equipment is pulled out of the USB interface.

3. The method according, to claim 1, wherein after the USB OTG driver triggers to enable an HPD function of the HDMI, the method further comprises:
the MHL driver setting an electrical level of an HPD pin of the HDMI to a high electrical level.

4. The method according to claim 1, wherein: the step that the USB OTG driver triggering to enable the HPD function of the HDMI comprises:
the USB OTG driver sending to an MHL driver a first notification which indicates that the MHL, equipment is plugged in the USB interface;
the MHL driver sending to an HDMI driver a second notification which indicates to enable the HPD function of the HDMI; and
the HDMI driver enabling the HPD function of the HDMI after receiving the second notification.

5. The method according to claim 2, wherein before the step that the MHL driver triggers to disenable the HPD function of the HDMI, the method further comprises:
the MHL driver setting the electrical level of the HPD pin of the HDMI to a low electrical level.

6. The method according to claim 5, wherein after the step that the MHL driver setting the electrical level of the HPD pin of the HDMI to the low electrical level, the method further comprises:
an HDMI driver sending to the MHL driver a third notification for indicating that the electrical level of the HPD pin is the low electrical level through executing a pre-registered callback function when it is detected that the electrical level of the HPD pin is the low electrical level; and
the step that the MHL driver triggering to disenable the HPD function of the HDMI comprises:
the MHL driver sending to the HDMI driver a fourth notification for indicating to disenable the HPD function of the HDMI through executing the callback function after receiving the third notification; and
the HDMI driver disenabling the HPD function of the HDMI after receiving the fourth notification.

7. A mobile terminal, wherein: the mobile terminal comprises a USB interface and an HDMI, and an operating mode of the USB interface is compatible with a USB OTG mode and an MHL mode of the mobile terminal, the mobile terminal further comprises:
a memory having instructions stored thereon;
a processor configured to execute the instructions to perform operations for controlling, comprising:
a USB OTG driver detecting whether MHL equipment is plugged in the USB interface; and
the USB OTG driver triggering to enable an HPD function of the HDMI if the USB OTG driver detects that the MHL equipment is plugged in the USB interface.

8. The mobile terminal according to claim 7, wherein the processor is further configured to perform:
an MHL driver detecting whether MHL equipment is pulled out of the USB interface; and
the MHL driver triggering to disenable the HPD function of the HDMI if the MHL driver detects that the MHL equipment is pulled out of the USB interface.

9. The mobile terminal according to claim 7, wherein the processor is further configured to perform:
the MHL driver setting an electrical level of an HPD pin of the HDMI to a high electrical level.

10. The mobile terminal according to claim 7, wherein: the USB OTG driver triggering to enable the HPD function of the HDMI comprises:
the USB OTG driver sending to an MHL driver a first notification for indicating that the MHL equipment is plugged in the USB interface;
the MHL driver sending to an HDMI driver a second notification for indicating to enable the HPD function of the HDMI; and
the HDMI driver enabling the HPD function of the HDMI after receiving the second notification.

11. The mobile terminal according to claim 8, wherein the processor is further configured to perform:
the MHL driver setting the electrical level of the HPD pin of the HDMI to a low electrical level.

12. The mobile terminal according to claim 11, wherein the processor is further configured to perform:
an HDMI driver sending to the MHL driver a third notification for indicating that the electrical level of the HPD pin is the low electrical level through executing a pre-registered callback function when it is detected that the electrical level of the HPD pin is the low electrical level; and
the MHL driver triggering to disenable the HPD function of the HDMI comprises:
the MHL driver sending to the HDMI driver a fourth notification for indicating to disenable the HPD function of the HDMI through executing the callback function after receiving the third notification; and
the HDMI driver disenabling the HPD function of the HDMI after receiving the fourth notification.

13. A non-transitory computer readable medium, having computer programs stored thereon that, when executed by one or more processors of an electronic apparatus, cause the electronic apparatus to perform:
a USB OTG driver detecting whether bait equipment is plugged in the USB interface; and
the USB OTG driver triggering to enable an HPD function of the HDMI if the USB OTG driver detects that the MHL equipment is plugged in the USB interface.
